(19) United States
(12) Patent Application Publication
(10) Pub. No.: US 2011/0208530 A1
(43) Pub. Date: Aug. 25, 2011

(54) PORTABLE STORAGE MEDIUM FOR MEDICAL DIAGNOSIS

(75) Inventors: NATHAN JOSEPH NEBBE, CEDAR FALLS, IA (US); WILLIAM JORDAN FITZHUGH, NEWPORT NEWS, VA (US)

(73) Assignee: TELEMEDICINE INTERNATIONAL, L.L.C., CEDAR FALLS, IA (US)

(21) Appl. No.: 12/709,225

(22) Filed: Feb. 19, 2010

(51) Int. Cl. G06Q 50/00; G06F 13/12; G06F 15/16

(52) U.S. Cl. 705/2; 710/74; 709/219

(57) ABSTRACT

Described herein is a novel method for remote communication between a patient and physician. The described method of communication includes a portable storage medium which includes software and patient data. The software is designed to regularly prompt the patient to answer a series of questions relating to his medical care, then transfers that software to the patient's physician through a network connection. The described method also includes a method to store individual patient data in a manner that it is easily accessible to medical personnel in case of emergency without the need for the patient to provide a name, address, username, or password to the treating personnel.

### BACKGROUND OF THE INVENTION

In the United States and many other more developed nations, health care accessibility is often taken for granted. The wide disbursal of medical facilities and physicians makes regular checkups and post-surgical follow-ups nearly a routine and nonintrusive task. However, in many countries outside of the United States, medical care is not as easily available and the distribution of qualified physicians to treat post-surgical or regular patients is inadequate.

For example, in South America, most of the population is concentrated in one or more large cities, which occupy a small amount of space relative to the size of the country. The remainder of the population is spread out across the remainder of the country, with a corresponding smaller population density. Medical facilities in these areas are smaller and afford fewer specialists.

Transportation in more developed nations is also a much more easily accessible commodity. If a patient has to travel to a nearby city, private cars, public transportation, and air travel are readily accessible, making most destinations no more than a few hours' travel. Therefore, even for rare treatments, health care and treatment are accessible to the vast majority of the population in more developed nations.

In nations with more centralized populations, the need for infrastructure spending in remote areas is decreased. This results in fewer travel opportunities for individuals, making health care even more difficult to obtain for those outside of the major population centers.

Remote diagnosis and treatment is one possible solution to the relative difficulty in obtaining specific health care. Phone calls between doctors and patients can provide some amount of diagnosis and local doctors can prescribe pharmaceuticals or help in treatment of the patient. However, this requires coordination between the doctor and patients, and additional recordkeeping to record the content of these telephone calls. Additionally, neither the patient nor the locally treating physician will have access to the patient's records during this conversation, thereby complicating the ability of the local physician to treat the patient.

Remote diagnosis also only works when a patient has regular access to a local physician. In many cases, such access is prohibitively expensive (in time or resources) and may be unnecessary. If a patient is having few or no symptoms, he would be unlikely to spend the time or resources to visit a local doctor and arrange a remote diagnosis with a centrally located physician. However, even minor symptoms may be indicators of more serious problems, and the treating physician would need to know of these symptoms.

Alternatively, a patient may have what appear to be significant symptoms which are instead regularly occurring side effects. In this case, a patient may be dissatisfied with travelling to a local physician only to learn that the symptoms are without remedy. In this case, the patient, by being required to travel to a local physician unnecessarily, may be less likely to visit the physician when other or more serious symptoms arise.

An additional concern with the current system is conflicting or outdated reporting of symptoms or side effects in medical records. If medical records are not stored in a consistent digital format, then tracking the incidence of particular symptoms is more difficult.

Additionally, patients who have had transplants or other serious medical treatments may require emergency treatment after falling unconscious. Medical bracelets have been in use for some time, but these generally do not offer personal individualized medical records or a patient may require several separate bracelets. A central database of medical records is one solution; however this may require particular identifying information (such as a username and password) from the patient in order to be available. Additionally, an unconscious patient would be unable to provide a name or other non-biometric information for identification by an emergency room. A patient with a particular rare or unusual condition would need to be able to provide his particular medical records and suggested emergency care, without the need to be conscious at the time.

Therefore, there has been recognized a need in the art for a consistent method of maintaining medical records.

There has further been recognized a need in the art for a remote diagnosis system which allows communication between patient and central physician.

There has further been recognized a need in the art for a remote treatment system allowing communication between the central physician and local physician.

There has further been recognized a need in the art for a patient record of medical information which allows information to be easily ported from one physician to another.

There has further been recognized a need in the art for a patient record of medical information which may be accessed without compromising patient security and allowing emergency treatment of an unconscious patient.

There has further been recognized a need in the art for a consistent medical records querying and storage system which maintains uniform medical records among a variety of patients.

These problems and others which are readily apparent from the following description are sought to be overcome in the present invention.

### BRIEF SUMMARY OF THE INVENTION

The invention generally comprises a method and apparatus for remote diagnosis of a patient from a physician. The method generally comprises the steps of assigning a portable storage medium (in one example a USB flash drive) to a patient, prompting the patient for answers to questions relating to his health, and transmitting the answers to those questions to a physician. The physician is then notified of the patient's answers and provides treatment information. The treatment information may consist of instructions to visit a physician, increased medication, or any other well known medical communication.

### BRIEF DESCRIPTION OF THE DRAWINGS

FIG. 1 is a diagram of the data flow between a patient and physician through a server.

FIG. 2 is a flow chart according to one embodiment of the invention.

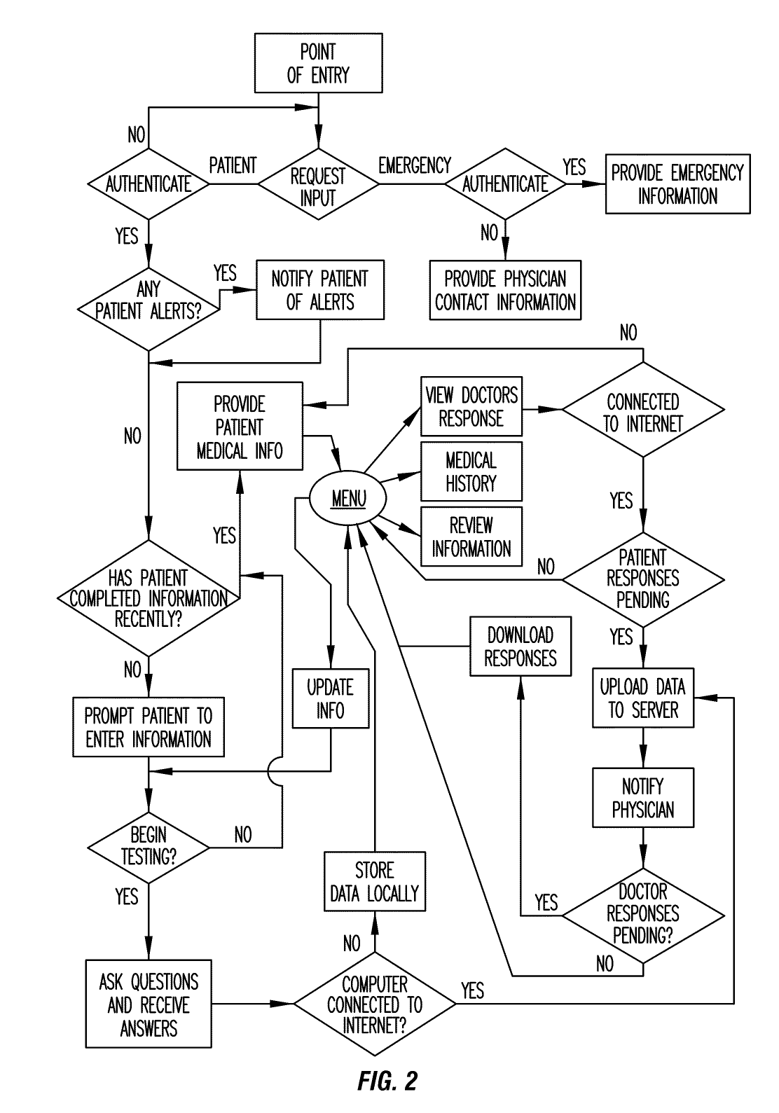

FIG. 3 is a screen shot of the main menu of the software.

FIG. 4 is a screen shot of the emergency information screen.

FIG. 5 is a screen shot of the patient log on screen.

FIG. 6 is a screen shot of the patient information screen.

FIG. 7 is a screen shot of the patient medical information review screen

FIG. 8 is a screen shot of the patient questionnaire.

FIG. 9 is a screen shot of the patient completion form.

FIG. 10 is a screen shot of the physician's patient registration screen.

FIG. 11 is a screen shot of the physician's new patient entry screen.

FIG. 12 is a screen shot of the physician's patient lookup screen.

FIG. 13 is a screen shot of the physician's patient password initialization screen.

FIG. 14 is a screen shot of the physician's confirmation screen for a new patient.

FIG. 15 is a screen shot of the physician's review alerts screen.

FIG. 16 is a screen shot of the physician's list of patient alerts.

FIG. 17 is a screen shot of the physician's view of a patient's responses to the health questionnaire.

### DETAILED DESCRIPTION OF THE PREFERRED EMBODIMENTS

The invention will now be described with reference to the attached figures, wherein numerals within the description correspond in kind to those used in the figures.

The invention generally relates to a method and apparatus for remote diagnosis and treatment of patients undergoing continuing treatment by a physician.

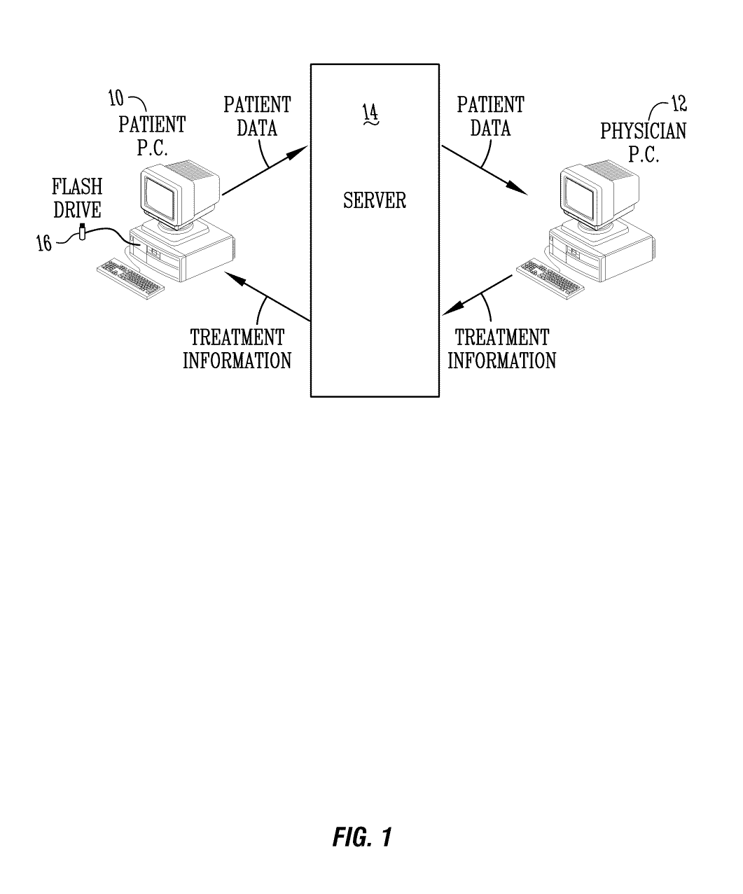

FIG. 1 generally illustrates the communication lines between a user and a physician through the method described herein.

As shown in FIG. 1, communication between the patient and physician is performed by means of an internet or other connection between a patient PC 10 and a physician PC 12 by means of a server 14. Communications from the patient may be transferred to the server 14, processed, and then the physician is alerted to the patient communication. The physician may then communicate back to the patient through the same server 14, providing remote diagnosis and treatment options.

According to one embodiment, the patient maintains a portable storage medium 16, such as a USB flash drive, compact disk, micro SD card, or other well known portable storage medium 16 having read and write capabilities. According to one embodiment, the portable storage medium 16 is a flash USB drive which is formed into a bracelet, keychain, or other commonly carried article. This makes the flash drive readily accessible for the patient as well as being easily perceived by medical personnel in case of emergency.

This portable storage medium 16 is issued to a patient and associated with a specific patient record at an initial consultation with the physician. The portable storage medium 16 may have a number of various data types thereon, for providing medical information.

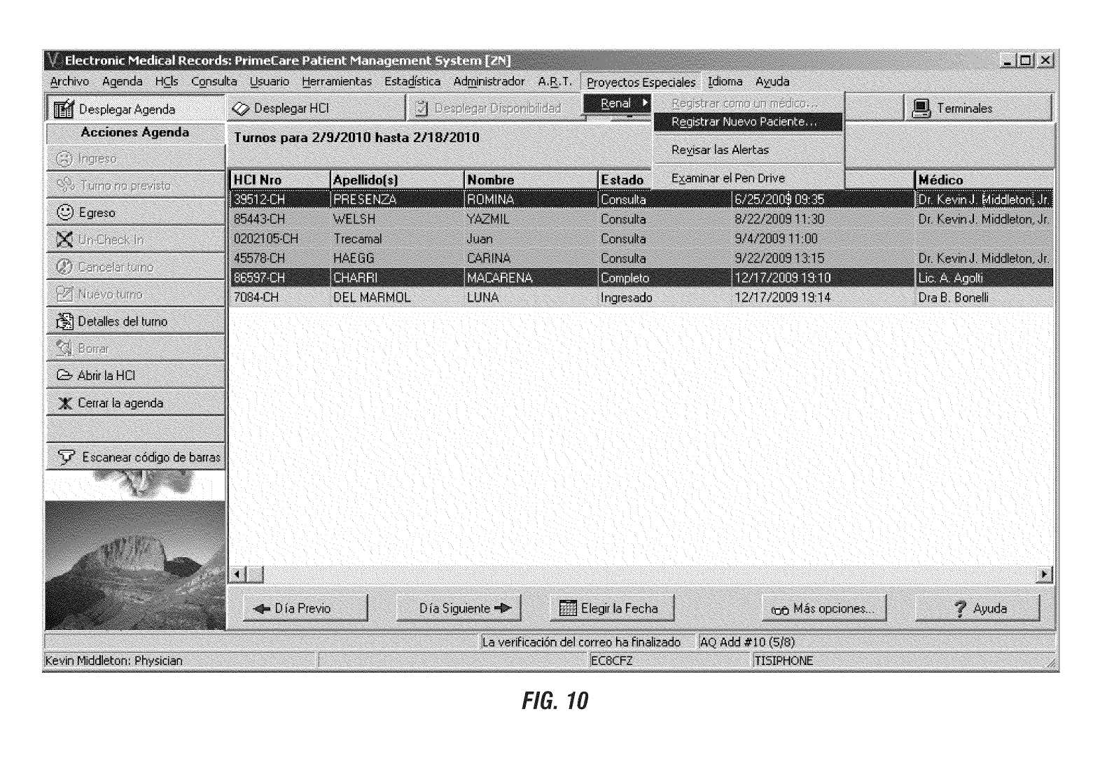

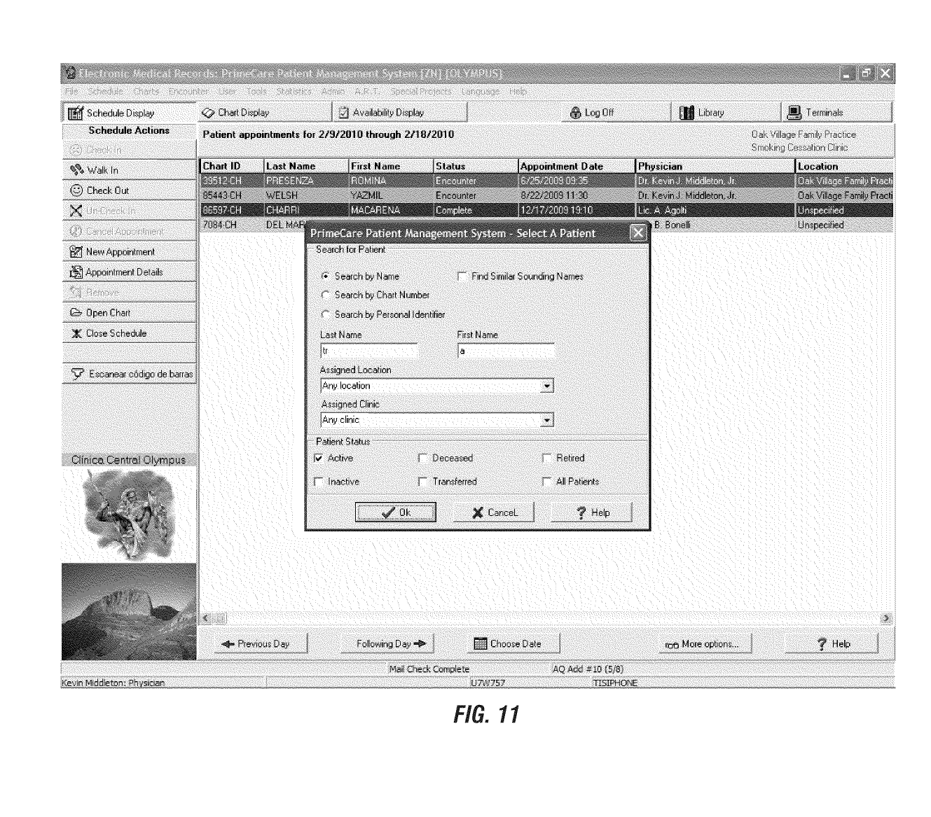

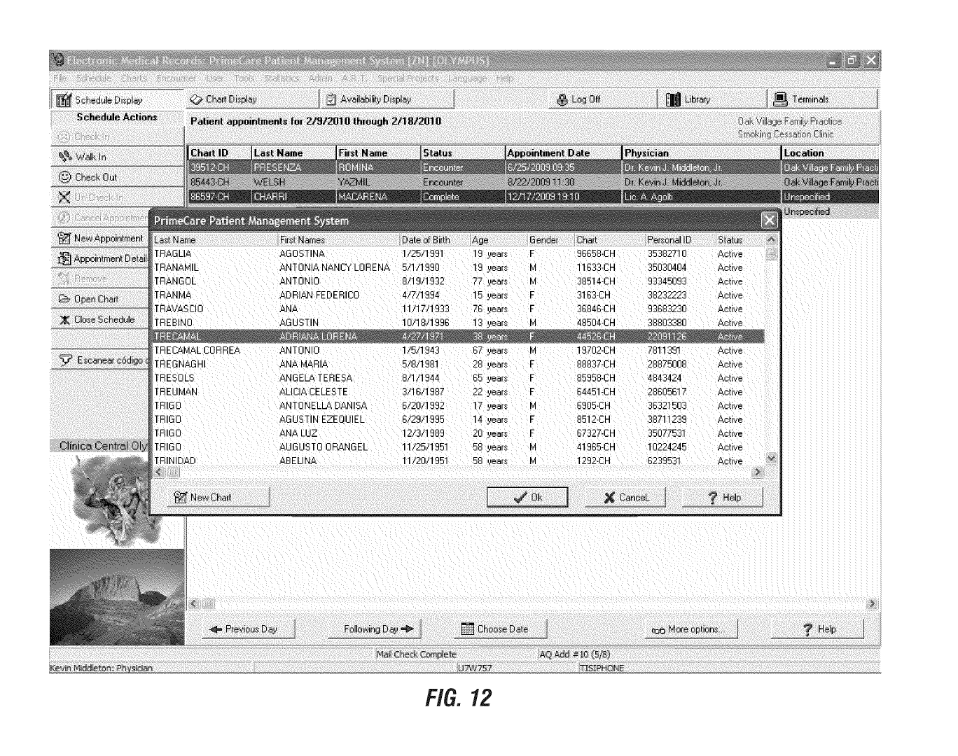

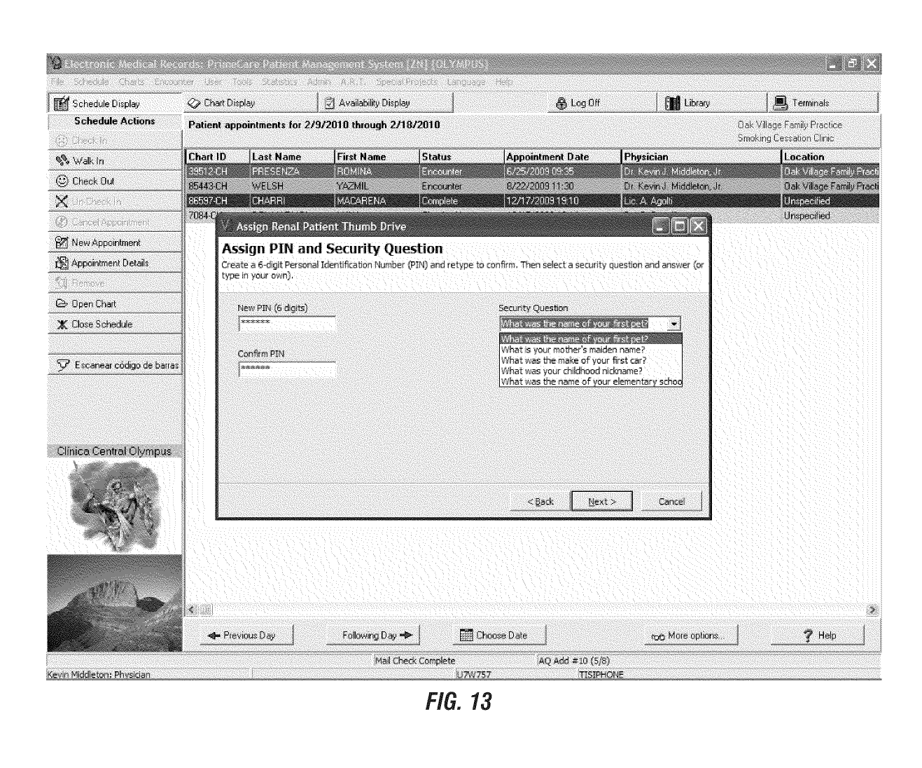

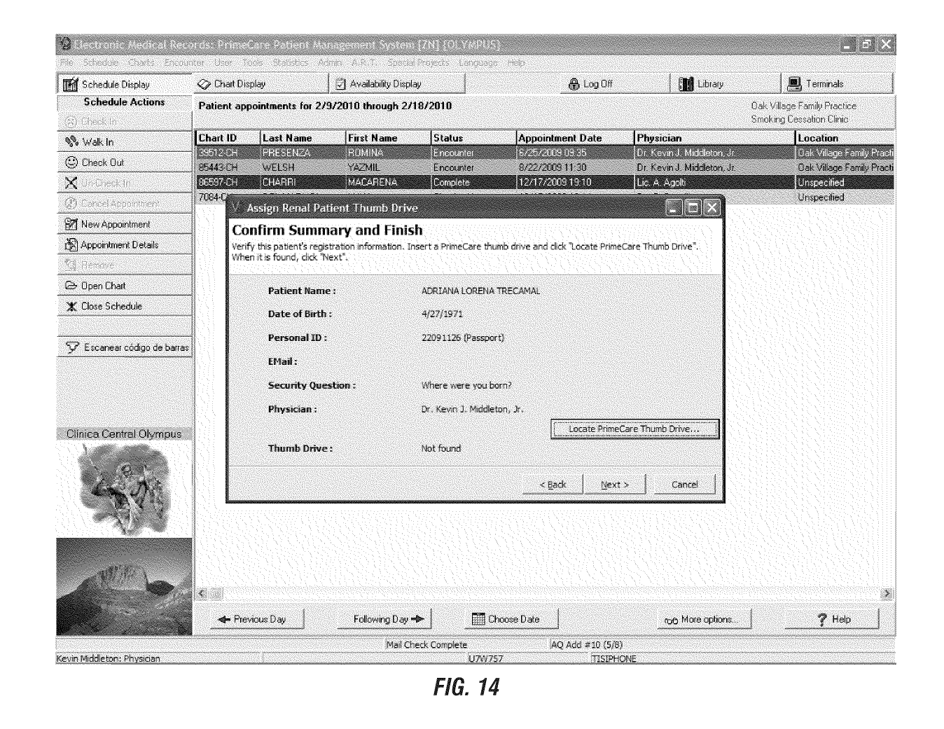

The association of a portable storage medium 16 to a patient is generally shown in FIGS. 10 to 14. According to one embodiment, the physician identifies the type of patient information to be associated with the portable storage medium 16 (for example, renal information). From the main physician screen, a physician selects a menu option to register a new renal patient (FIG. 10), enters patient data (FIG. 11), selects the proper patient (FIG. 12), provides a password and security question for the patient (FIG. 13), and associates the patient data with the portable storage medium 16 (FIG. 14). When the patient data (for example a first and last name) is entered by a physician, the local software looks up the patient information and identifies relevant medical information relating to renal care. Finally, the information is transferred to the portable storage medium 16 along with patient identifying information (see FIG. 14).

According to one embodiment, the patient's medical record is stored remotely on a central server 14. The patient's portable storage medium 16 therefore acts as a key, allowing access to the patient's medical records (or emergency information) for anyone in possession of the portable storage medium 16. According to this embodiment, in order for the patient or a local medical professional to access the patient's medical records, the portable storage medium 16 must be connected to the internet or a computer 10 otherwise in communication with the central server 14. Further according to this embodiment, security of the patient's private medical information can be secured by requiring particular software at the hosting computer 10. This software may be distributed freely or for a fee to medical companies. This check would prevent unauthorized access to medical records by non-medical personnel. Alternatively, or in concert with the identification software the program may require a password to access patient information, so that the patient may answer questions from a home or local computer 10 rather than a physician's office.

According to another embodiment, the patient's portable storage medium 16 maintains all of the patient's medical records, including textual information entered by a central physician and medical images provided by X-ray, CAT scans, or the like. The patient's medical records will likely be encrypted to prevent theft of these records by theft of the portable storage medium 16. The patient's medical records may also be backed up on either an independent or central server 14. Access to the patient's medical records would be by means of a username and/or password, emergency override, software on the computers of medical providers, or any other well known security protocols. Any of these checks may also require communication with the central server 14, allowing patients to report a stolen portable storage medium 16, thereby causing future attempts to access the information on the portable storage medium 16 to be unsuccessful.

A third option is for only selected patient information to be available on the portable storage medium 16. For example, if a patient has recently undergone kidney transplant, medical records relating to the surgery and relevant emergency care may be included on the portable storage medium 16. The patient's medical records may also be stored on a digital or other storage medium separate from the portable storage medium 16, such as a central server 14. This storage may either be the remaining patient data, or may include the data stored on the portable storage medium 16. According to this option, only limited patient data may be compromised in case of loss or theft of the portable storage medium 16.

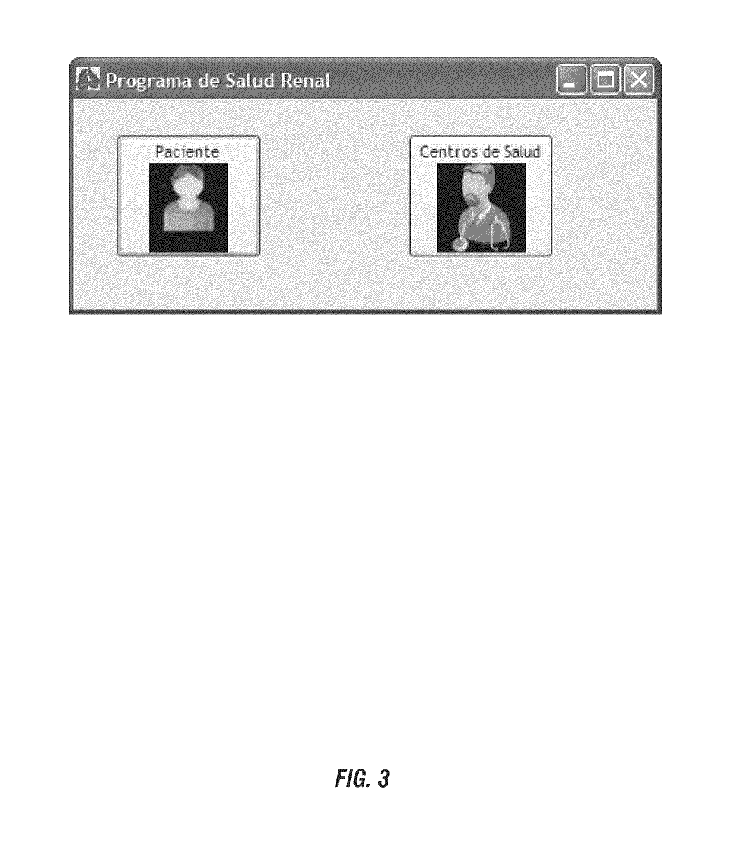

Also included on the portable storage medium 16 is software for enabling communication between the patient and primary physician. Screenshots of this software are generally shown in FIGS. 3 to 17.

According to one embodiment, when a user connects the portable storage medium 16 to a computer, the software is automatically executed and the user is prompted to provide specific input. For example, as shown in FIG. 3, the user is first prompted to enter whether this is patient access or emergency access. At this point, the software may also query the local computer to determine if the computer has an interne connection, or is otherwise in communication with the central server 14. If a connection is present, the software may then query the central server 14 through the connection to upload or download information relevant to patient treatment, diagnosis, or software updates.

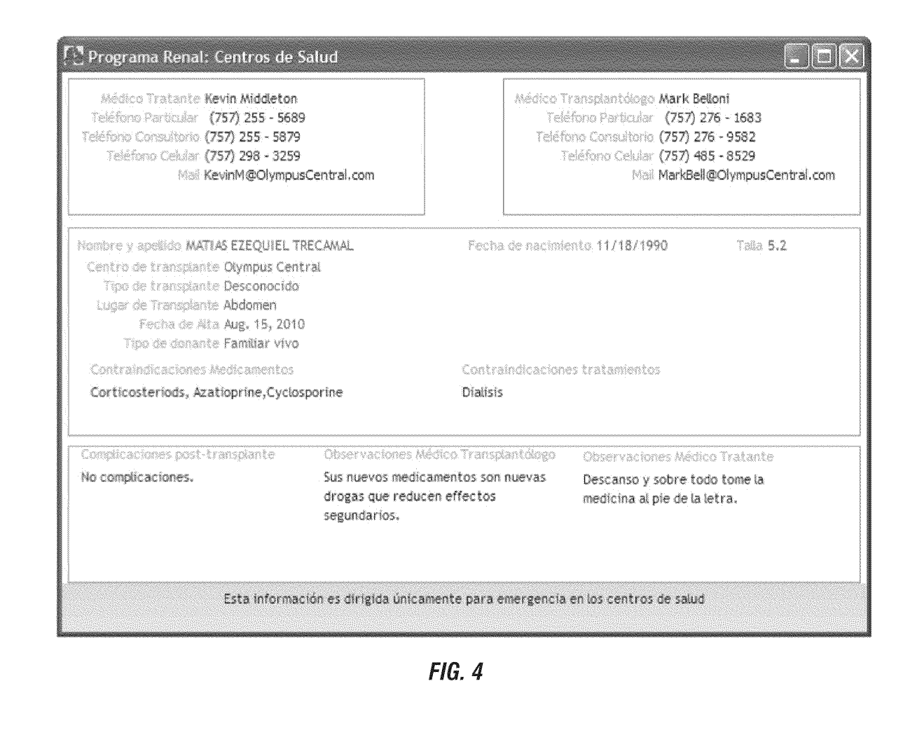

FIG. 4 demonstrates a sample emergency access screen. This screen provides patient information, the name of the treating physician, any medications the patient is on, any ongoing treatments (e.g. dialysis), and any information deemed relevant by the patient's main or transplant physician.

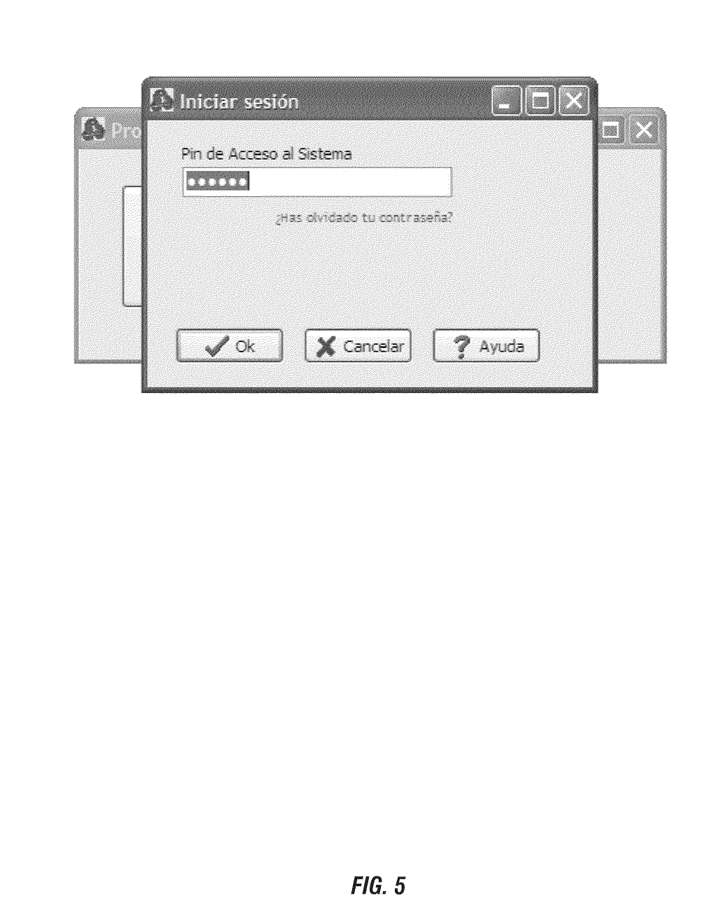

FIG. 5 shows the patient password entry screen which is displayed when a user indicates that he would like to access the more detailed patient information. This prevents unauthorized access by a third party to the information.

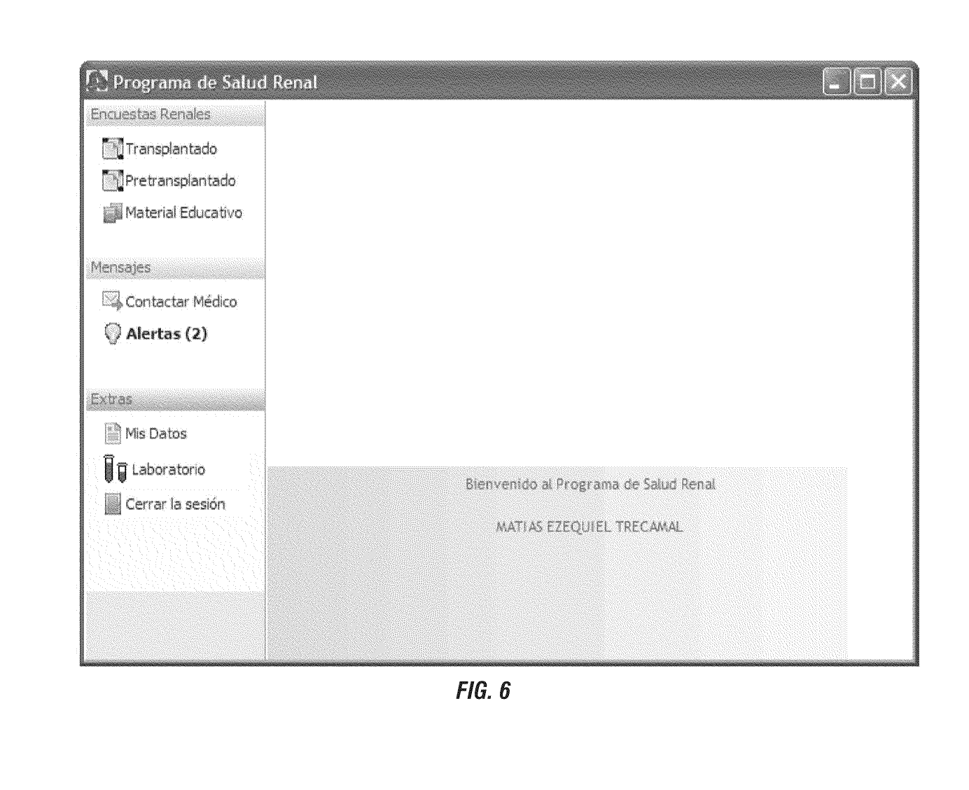

FIG. 6 shows the patient information screen. This screen displays important alerts to the patient (e.g. physician instructions), allows the patient to enter medical information (e.g. lab results), displays patient medical information, allows the patient to take the ongoing treatment survey as instructed by his physician, or any other information which may be relevant for a patient to know.

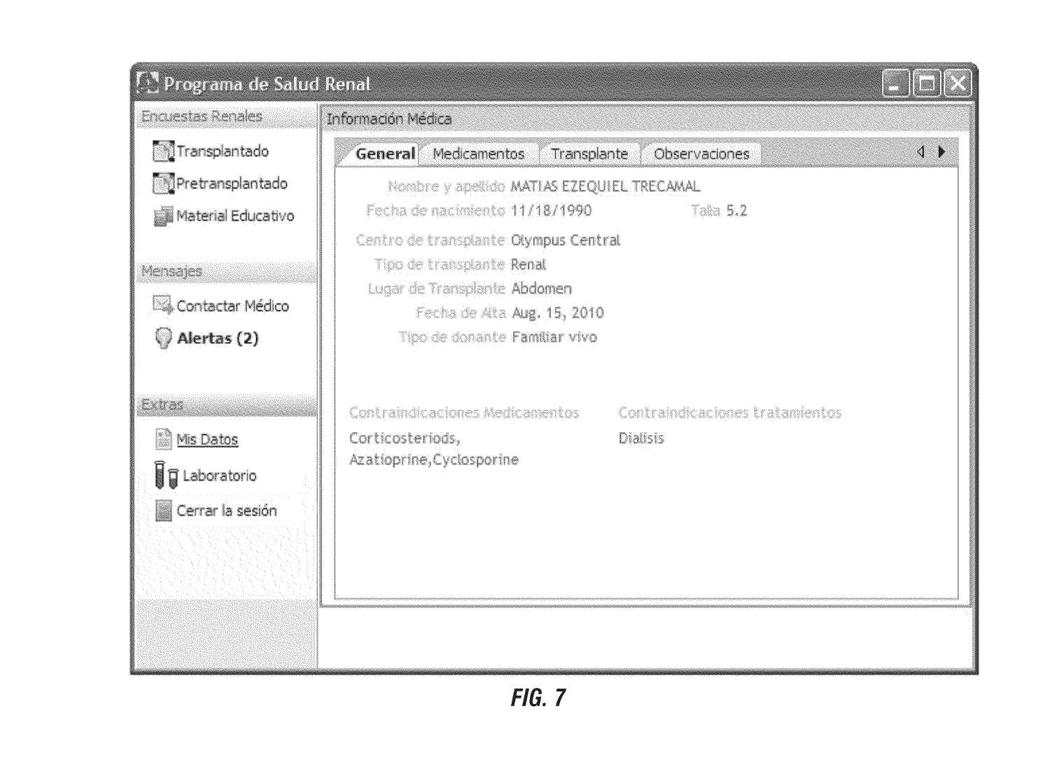

FIG. 7 illustrates the general patient medical information. This particular view displays information relating to the patient's kidney transplant, including the date of the transplant, pharmaceuticals that the patient is currently taking, and other medical treatment the patient is undergoing (dialysis).

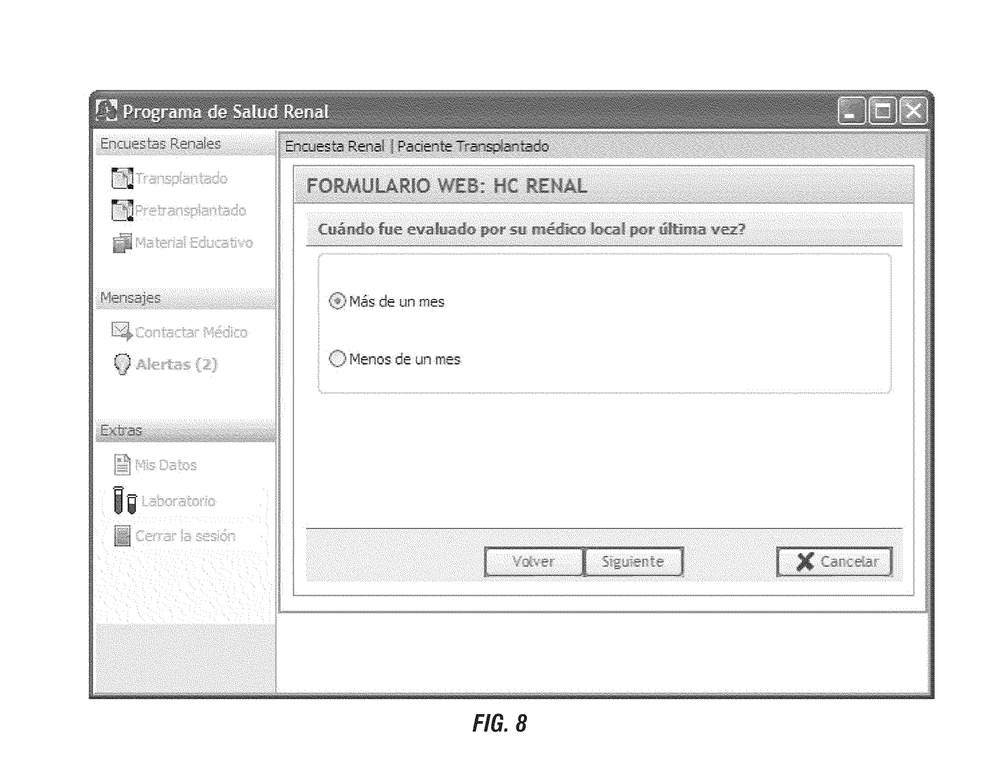

The central feature of the software is shown in FIG. 8 and allows the patient to enter health information, submit it to the physician, for the purpose of receiving treatment information from his physician. Patients will be instructed by the physician (and may be reminded by the software) to regularly provide updated information regarding their health. This is most commonly done through a questionnaire embedded in the software program. The questions will preferably be keyed to the particular reason for the patient's visit to the central physician. For example, if a patient has undergone a kidney transplant, he may be asked questions regarding diet, use of medications, information relating to his urine, or the last time he visited a local physician.

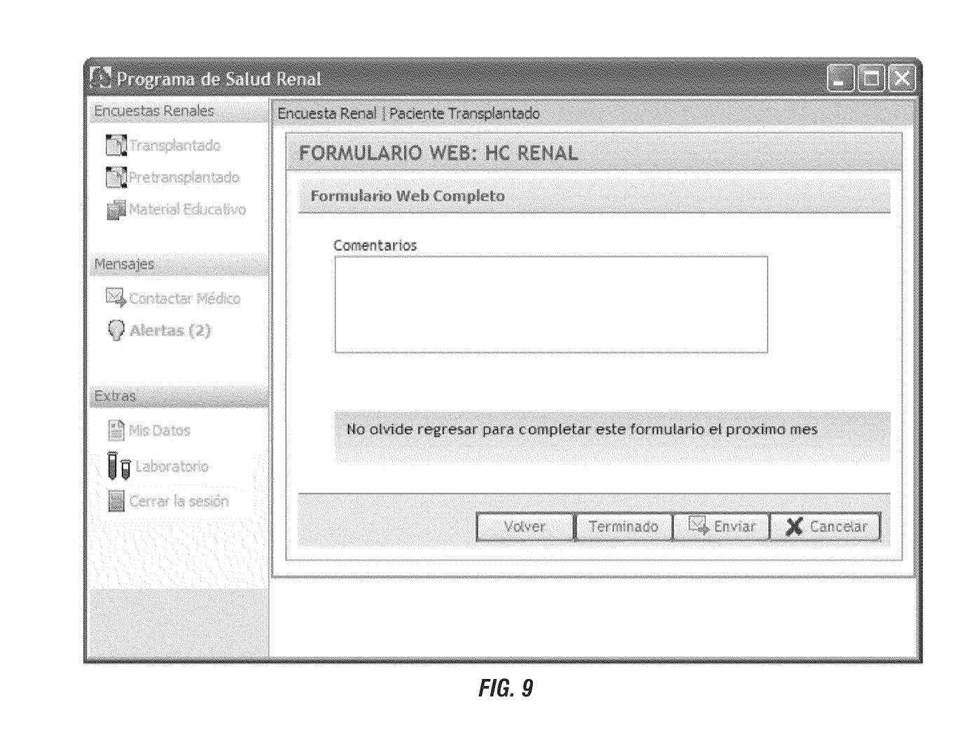

Once the patient has answered the questions regarding his health, and provided any additional relevant information not covered by the questionnaire (FIG. 9), the information is either stored locally or transferred to the server 14 for storage. Local storage may be on the local computer or on the portable storage medium 16. Once the local computer (or portable storage medium 16) is connected to the internet or other network (or internet-connected computer) in communication with the server 14, the information regarding the patient's information is transferred to the server 14. By utilizing local storage to store the patient's information, the patient may answer the questionnaire at any available computer without requiring an internet connection. Once the patient has access to an internet connection, the data can be quickly and/or automatically transferred to the server 14, thereby allowing more widespread use of the software.

When information is received by the central server 14, the data is correlated to patient information and particular diagnostic questions. For example, a patient may be treated for both kidney and heart issues, but only answer questions relating to heart issues. The patient's data structure regarding heart issues will then be updated and data related to kidney treatment will remain unmodified. The information data structure for that patient is then updated and the doctor (or doctors) associated with the patient's treatment is identified. The identified doctor is then notified that the patient's information has been updated. This may be either a simple notification of an update, or may be a detailed update regarding the patient's answers to each question. For example, if the information is sent to a beeper or via cell phone text message, the update may be brief, possibly including the patient's name, hospital I.D. number, medical issue, and/or a statement that the patient has answered questions. As a further example, if the update information is sent by email or printed for the physician's local records, the update would be detailed, including all of the questions, patient's associated answers, detailed patient information, and may provide additional medical history.

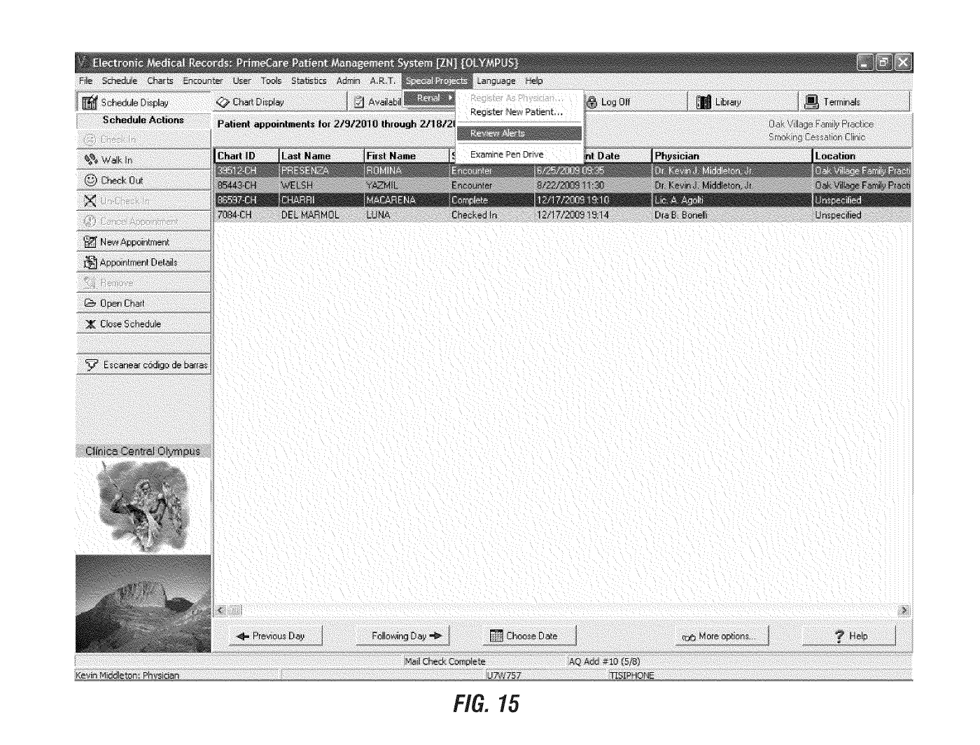

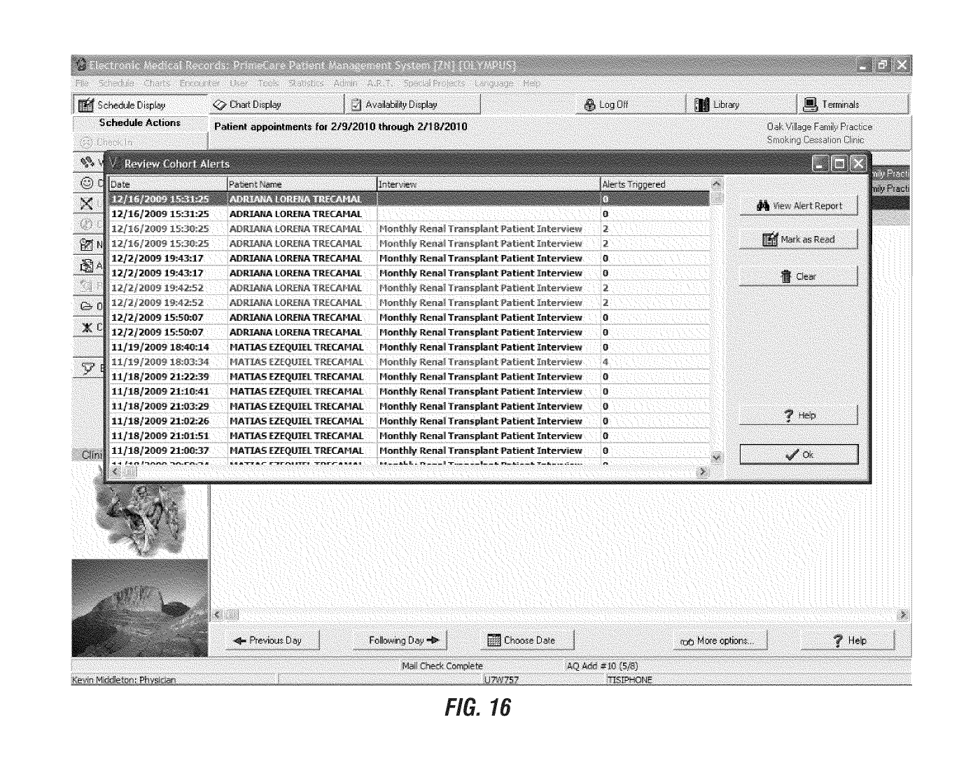

The physician review screens are shown in FIGS. 15-17. FIG. 15 demonstrates the physician's main screen which contains regular physician information, such as information relating to the physician's daily appointments. The physician then accesses patient alerts through the menu selection and is provided with FIG. 16.

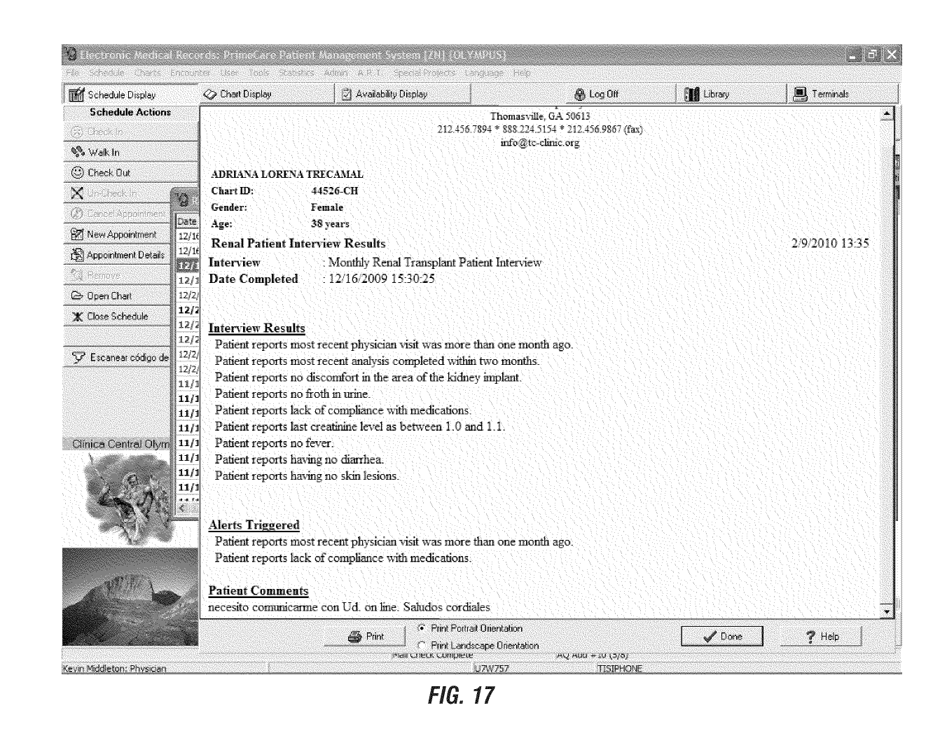

FIG. 16 shows a list of all of the alerts provided by patients. Each alert lists the patient information, the interview or questionnaire taken, and any alarming answers to questions (labeled as alerts). Each alert is also listed as read (normal text) or unread (bold text), so that a physician can organize his responses. If the physician desires to see the full information submitted by a patient, the physician doubleclicks or otherwise opens the patient record, thereby displaying FIG. 17.

FIG. 17 shows the patient's interview responses provided by the patient through the software. The software automatically appends the patient information including name, address, gender, age, and other relevant patient information. Results from the patient interview or questionnaire are displayed along with any alerts or additional comments provided by the patient.

Once the physician is in possession of the patient's medical information, either through an update or querying the server 14, the physician may provide a diagnosis or information relevant to the patient's ongoing treatment. For example, the physician may prescribe additional medications, request the patient enter a local facility for various of testing, or instruct the patient to seek out emergency treatment. This information may be provided in a number of ways, such as: responses to a series of questions; scanned handwritten notes; information typed into a text box; or any other means of digital communication well known to those in the art. The physician, having completed his diagnosis, then submits this information to the server 14 where it is stored and a flag is added to the patient's information record. The physician may also request additional data from the patient. This additional data may require the physician to add new questions for the patient, or the physician may be able to change the questions that the patient is to be asked when he next accesses the software.

When the server 14 is next queried by a computer 12 in connection with a flagged patient's portable storage medium 16, the patient may be informed on his screen that an update has been provided by his physician. Download and display of this update may be either automatic or require some user action, such as clicking a button or entering his password. Additionally, if the information may be harmful or distressing to the patient, the information may be restricted to a local physician's password or require specific software on the connected computer in order to be displayed. The central physician may then communicate this fact to a local physician who would first see the information before consulting with the patient.

According to the above described system, the patient is able to regularly communicate with his treating physician, regardless of intervening distance and travel opportunities, and the patient maintains a record of information relevant to emergency treatment.

The described system may also have further improvements to increase the usefulness of the system in providing patient care.

According to one improvement, the system may be utilized to provide general health consulting and services to individuals located in remote areas. If these individuals have access to the interne, such as through satellite or cell technology, they can use a series of predetermined questions to communicate with a doctor and receive diagnostic information for general health care.

Other methods of communication between the physician and patient may also be utilized, apart from a separate portable storage medium 16 and internet-capable computer 12. According to one embodiment, a single device may contain both the patient data and provide communication between the patient and central server 14. One example of this is an application capable of being run on a cellular or satellite phone. The phone may store patient information when the patient is outside of the range of his cellular carrier. When the patient next enters an area which can handle a sufficient volume of data, (for example, a 3G, or third generation, network) the patient's answers to questions are transmitted to the central server 14 through the patient's cellular or satellite service.

Another alternative to the above described examples is a program which includes text-to-speech and speech-to-text capabilities. This option would allow blind patients to answer questions regarding their general health without the help of another person. Such a system may also be helpful for patients who are unable to use a computer, or not used to using a computer.

The invention has been described with regard to one or more embodiments; however those skilled in the art will understand that other variations or alternative methods of performing the desired tasks may also be used without departing from the spirit of the invention. Any limitations to the invention appear in the claims as allowed, and the disclosure should not be limiting on the scope of protection afforded.

What is claimed is:

1. A method for remote diagnosis of a patient comprising:
providing a portable media storage device containing a patient's health care record;
providing software on the portable media storage device;
providing a server in network communication with said portable media storage device;
querying the patient regarding an issue of health concern;
receiving answers from the patient;
uploading the answers to the server;
notifying a physician through the server of the patient's answers;
receiving the physician's instructions from the server; and
displaying the instructions to the patient.

2. The method of claim 1 wherein the portable media storage device comprises a USB flash drive.

3. The method of claim 2 wherein notification of the physician comprises one of the following: email; text message; beeper; printed communication; facsimile; or other electronic means.

4. The method of claim 2 further comprising the step of receiving the communications to the software.

5. The method of claim 4 further comprising the step of providing patient information on the portable media storage device.

6. The method of claim 5 further comprising the step of communicating the instructions to a physician local to the patient.

7. The method of claim 6 further comprising the step of providing the local physician with decryption software.

8. The method of claim 7 further comprising the step of providing the patient data on the portable media storage device to the local physician.

9. The method of claim 8 wherein the patient data comprises emergency treatment information.

10. A method of treating a remotely located patient comprising the steps of:
providing a portable storage medium;
assigning a unique patient identifier to the portable storage medium;
assigning a diagnostic program to the unique patient identifier;
providing the portable storage medium to a patient identified by the unique patient identifier;
receiving diagnostic information from the portable storage medium;
determining treatment information corresponding to the received diagnostic information;
transmitting the treatment information to the portable storage medium.

11. The method of claim 10 wherein the portable storage medium comprises a USB flash drive.

12. The method of claim 10 further comprising the step of instructing the patient to regularly provide health updates to the portable storage medium.

13. The method of claim 12 wherein the diagnostic information is transmitted to the physician through a central server.

14. The method of claim 13 wherein the treatment information is transmitted to the portable storage medium through a central server.

15. The method of claim 14 wherein the diagnostic information comprises answers to questions relating to the patient's specific health concern.

16. A method of receiving remote treatment comprising:
providing a portable storage medium;
assigning a unique patient identification with the portable storage medium;
providing the portable storage medium to a patient corresponding to the unique patient identification;
connecting the portable storage medium to an internet capable computer;
loading software from the portable storage medium;
providing a series of questions from the software to the patient;
answering the series of questions;
transmitting answers to the series of questions to a central server;
receiving treatment information from the central server.

17. The method of claim 16 wherein the portable storage medium comprises a flash drive.

18. The method of claim 16 further comprising the step of selecting an option to answer a series of questions.

19. The method of claim 16 wherein the portable storage medium comprises confidential patient information.

20. The method of claim 19 further comprising the step of providing the patient data to an emergency physician.
